(19) United States
(12) Patent Application Publication
(10) Pub. No.: US 2021/0334706 A1
(43) Pub. Date: Oct. 28, 2021

(54) AUGMENTATION DEVICE, AUGMENTATION METHOD, AND AUGMENTATION PROGRAM

(71) Applicant: NIPPON TELEGRAPH AND TELEPHONE CORPORATION, Tokyo (JP)

(72) Inventors: Shinya YAMAGUCHI, Musashino-shi, Tokyo (JP); Takeharu EDA, Musashino-shi, Tokyo (JP); Sanae MURAMATSU, Musashino-shi, Tokyo (JP)

(73) Assignee: NIPPON TELEGRAPH AND TELEPHONE CORPORATION, Tokyo (JP)

(21) Appl. No.: 17/271,205

(22) PCT Filed: Aug. 22, 2019
(86) PCT No.: PCT/JP2019/032863

§ 371 Date: Feb. 25, 2021

(30) Foreign Application Priority Data
Aug. 27, 2018 (JP) 2018-158400

(51) Int. Cl. G06N 20/00

(52) U.S. Cl. CPC G06N 20/00; G06K 9/6262

(57) ABSTRACT

An augmentation apparatus (10) causes a generative model that generates data from a label to learn first data and second data to which a label has been added. In addition, the augmentation apparatus (10) uses the generative model that learned the first data and the second data to generate data for augmentation from the label added to the first data. In addition, the augmentation apparatus (10) adds the label added to the first data to augmented data obtained by integrating the first data and the data for augmentation.

### TECHNICAL FIELD

The present disclosure relates to an augmentation apparatus, an augmentation method, and an augmentation program.

### BACKGROUND ART

The maintenance of training data in a deep learning model requires a high cost. The maintenance of training data includes not only collection of training data, but also addition of annotations, such as labels, to the training data.

In the related art, rule-based data augmentation is known as a technique to reduce such a cost for the maintenance of training data. For example, a method of adding a modification such as inversion, scaling, noise addition, or rotation to an image used as training data according to specific rules to generate another piece of training data is known (e.g., see Non Patent Literature 1 or 2). In addition, in a case in which training data is speech or text, similar rule-based data augmentation may be performed.

### CITATION LIST

### Non Patent Literature

Non Patent Literature 1: Patrice Y. Simard, Dave Steinkraus, and John C. Platt, “Best Practices for Convolutional Neural Networks Applied to Visual Document Analysis”, in Proceedings of the Seventh International Conference on Document Analysis and Recognition—Volume 2, ICDAR '03, pp. 958, Washington, D.C., USA, 2003, IEEE Computer Society.
Non Patent Literature 2: Alex Krizhevsky, Ilya Sutskever, and Geoffrey E. Hinton, “ImageNet Classification with Deep Convolutional Neural Networks”, in Proceedings of the 25th International Conference on Neural Information Processing Systems—Volume 1, NIPS'12, pp. 1097 to 1105, USA, 2012, Curran Associates Inc.
Non Patent Literature 3: C. Szegedy, Wei Liu, Yangqing Jia, P. Sermanet, S. Reed, D. Anguelov, D. Erhan, V. Vanhoucke, and A. Rabinovich, “Going Deeper with Convolutions”, in 2015 IEEE Conference on Computer Vision and Pattern Recognition (CVPR), pp. 1 to 9, June 2015.
Non Patent Literature 4: Tom Ko, Vijayaditya Peddinti, Daniel Povey, and Sanjeev Khudanpur, “Audio Augmentation for Speech Recognition”, in INTERSPEECH, pp. 3586 to 3589. ISCA, 2015.
Non Patent Literature 5: Z. Xie, S. I. Wang, J. Li, D. Levy, A. Nie, D. Jurafsky, and A. Y. Ng, “Data Noising as Smoothing in Neural Network Language Models”, in International Conference on Learning Representations (ICLR), 2017.
Non Patent Literature 6: Mehdi Mirza and Simon Osindero, “Conditional Generative Adversarial Nets”, CoRR abs/1411.1784 (2014)
Non Patent Literature 7: D. Cheng, Y. Gong, S. Zhou, J. Wang, and N. Zheng, “Person Re-identification by Multi-Channel Parts-Based CNN with Improved Triplet Loss Function”, 2016 IEEE Conference on Computer Vision and Pattern Recognition (CVPR), Las Vegas, N V, 2016, pp. 1335 to 1344. doi: 10.1109/CVPR.2016.149

### SUMMARY OF THE INVENTION

### Technical Problem

However, techniques in the related art have the problem that there are less variations in training data obtained from data augmentation and the accuracy of the model may not be improved. In particular, it is difficult in rule-based data augmentation of the related art to increase variations in attributes of training data, which limits improvement in the accuracy of the model. For example, using the rule-based data augmentation described in Non Patent Literature 1 and 2, it is difficult to generate an image with modified attributes such as “window”, “cat”, and “front” of an image of a cat facing the front at the window.

### Means for Solving the Problem

In order to solve the above-described problem and achieve the objective, an augmentation apparatus includes a learning unit configured to cause a generative model, which is configured to generate data from a label, to learn first data with a first label added and second data with a second label added, a generating unit configured to use the generative model that learned the first data and the second data to generate data for augmentation from the first label added to the first data, and an adding unit configured to add the first label added to the first data to augmented data obtained by integrating the first data and the data for augmentation.

### Effects of the Invention

According to the present disclosure, it is possible to increase variations in training data obtained through data augmentation and improve the accuracy of the model.

### BRIEF DESCRIPTION OF DRAWINGS

FIG. 1 is a diagram illustrating an example of a configuration of an augmentation apparatus according to a first embodiment.

FIG. 2 is a diagram illustrating an example of a generative model according to the first embodiment.

FIG. 3 is a diagram for describing a learning processing of the generative model according to the first embodiment.

FIG. 4 is a diagram for describing a generation processing of an augmented image according to the first embodiment.

FIG. 5 is a diagram for describing an adding processing according to the first embodiment.

FIG. 6 is a diagram for describing a learning processing of a target model according to the first embodiment.

FIG. 7 is a diagram illustrating an example of an augmented dataset generated by the augmentation apparatus according to the first embodiment.

FIG. 8 is a flowchart illustrating processing of the augmentation apparatus according to the first embodiment.

FIG. 9 is a diagram illustrating effects of the first embodiment.

FIG. 10 is a diagram illustrating an example of a computer that executes an augmentation program.

### DESCRIPTION OF EMBODIMENTS

Hereinafter, an embodiment of an augmentation apparatus, an augmentation method, and an augmentation program according to the present application will be described in detail with reference to the drawings. Note that the present disclosure is not limited to the embodiment which will be described below.

### Configuration of First Embodiment

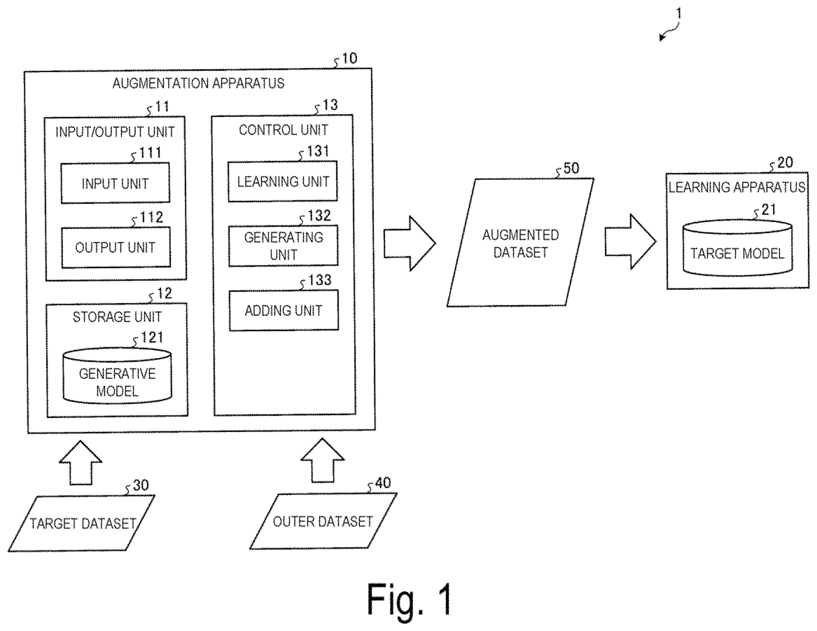

First, a configuration of an augmentation apparatus according to a first embodiment will be described with reference to FIG. 1. FIG. 1 is a diagram illustrating an example of a configuration of an augmentation apparatus according to the first embodiment. As illustrated in FIG. 1, a learning system 1 has an augmentation apparatus 10 and a learning apparatus 20.

The augmentation apparatus 10 uses an outer dataset 40 to perform data augmentation of a target dataset 30 and output an augmented dataset 50. In addition, the learning apparatus 20 has a target model 21 to perform learning by using the augmented dataset 50. The target model 21 may be a known model for performing machine learning. For example, the target model 21 is MCCNN with Triplet loss described in Non Patent Literature 7.

In addition, each dataset in FIG. 1 is data with a label to be used by the target model 21. That is, each dataset is a combination of data and a label. For example, if the target model 21 is a model for image recognition, each dataset is a combination of image data and a label. In addition, the target model 21 may be a speech recognition model or a natural language recognition model. In such a case, each dataset is speech data with a label or text data with a label.

Here, an example in which each dataset is a combination of image data and a label will be mainly described. In addition, in the following description, data representing an image in a computer-processible format will be referred to as image data or simply an image.

As illustrated in FIG. 1, the augmentation apparatus 10 includes an input/output unit 11, a storage unit 12, and a control unit 13. The input/output unit 11 includes an input unit 111 and an output unit 112. The input unit 111 receives input of data from a user. The input unit 111 is, for example, an input device such as a mouse or a keyboard. The output unit 112 outputs data through displaying a screen or the like. The output unit 112 is, for example, a display device such as a display. In addition, the input/output unit 11 may be a communication interface such as a Network Interface Card (NIC) for inputting and outputting data through communication.

The storage unit 12 is a storage device such as a Hard Disk Drive (HDD), a Solid State Drive (SSD), or an optical disc. Note that the storage unit 12 may be a semiconductor memory capable of rewriting data, such as a Random Access Memory (RAM) or a flash memory, and a Non Volatile Static Random Access Memory (NVSRAM). The storage unit 12 stores an Operating System (OS) or various programs that are executed in the augmentation apparatus 10. Further, the storage unit 12 stores various types of information used in execution of the programs. In addition, the storage unit 12 stores a generative model 121.

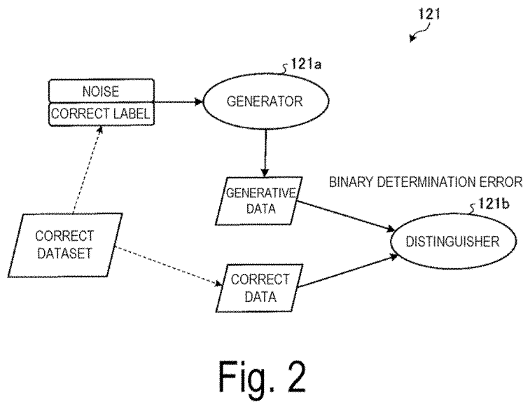

Specifically, the storage unit 12 stores parameters used in each processing operation by the generative model 121. In the present embodiment, the generative model 121 is assumed to be a Conditional Generative Adversarial Networks (CGAN) described in Non Patent Literature 6. Here, the generative model 121 will be described using FIG. 2. FIG. 2 is a diagram illustrating an example of the generative model according to the first embodiment.

As illustrated in FIG. 2, the generative model 121 has a generator 121a and a distinguisher 121b. For example, all of the generator 121a and the distinguisher 121b are neural networks. Here, a correct dataset is input to the generative model 121. The correct dataset is a combination of correct data and a correct label added to the correct data. In a case in which the correct data is an image of a specific person, for example, the correct label is an ID for identifying the person.

The generator 121a generates generative data from the correct label input with predetermined noise. Furthermore, the distinguisher 121b calculates, as a binary determination error, a degree of deviation between the generative data and the correct data. Then, in the learning of the generative model 121, parameters of the generator 121a are updated so that the error becomes smaller. On the other hand, parameters of the distinguisher 121b are updated so that the error becomes larger. Note that each of the parameters for learning is updated by using a method of backward propagation of errors (Backpropagation).

In other words, the generator 121a is designed to be able to generate generative data that is likely to be distinguished as the same as the correct data by the distinguisher 121b through learning. On the other hand, the distinguisher 121b is designed to be able to recognize the generative data as generative data and recognize the correct data as correct data through learning.

The control unit 13 controls the entire augmentation apparatus 10. The control unit 13 may be an electronic circuit such as a Central Processing Unit (CPU) or a Micro Processing Unit (MPU), or an integrated circuit such as an Application Specific Integrated Circuit (ASIC) or a Field Programmable Gate Array (FPGA). In addition, the control unit 13 includes an internal memory for storing programs defining various processing procedures and control data, and executes each of the processing operations using the internal memory. Further, the control unit 13 functions as various processing units by operating various programs. The control unit 13 includes, for example, a learning unit 131, a generating unit 132, and an adding unit 133.

The learning unit 131 causes the generative model 121 that generates data from a label to learn first data with a first label added and second data with a second label added. The target dataset 30 is an example of a combination of the first data and the first label added to the first data. In addition, the outer dataset 40 is an example of a combination of the second data and the second label added to the second data.

Here, the target dataset 30 is assumed to be a combination of target data and a target label added to the target data. Also, the outer dataset 40 is assumed to be a combination of outer data and an outer label added to the outer data.

The target label is a label to be learned by the target model 21. For example, if the target model 21 is a model for recognizing a person in an image, the target label is an ID for identifying the person reflected in the image of the target data. In addition, if the target model 21 is a model for recognizing text from speech, the target label is text obtained by transcribing speech from the target data.

The outer dataset 40 is a dataset for augmenting the target dataset 30. The outer dataset 40 may be a dataset of different domains from the target dataset 30. Here, a domain is a unique feature of a dataset represented by data, a label, and generative distribution. For example, the domain of a dataset in which data is X₀ and the label is Y₀ is represented as (X₀, Y₀, P(X₀, Y₀)).

Here, in one example, the target model 21 is assumed to be an image recognition model, and the learning apparatus 20 is assumed to learn the target model 21 such that an image of a person whose ID is “0002” can be recognized from an image. In this case, the target dataset 30 is a combination of a label “ID: 0002” and an image in which the person is known to reflect. In addition, the outer dataset 40 is a combination of a label indicating an ID other than “0002” and an image in which the person corresponding to that ID is known to reflect.

Furthermore, the outer dataset 40 may not necessarily have an accurate label. That is, a label of the outer dataset 40 may be a label that is distinguishable from the label of the target dataset 30 and may mean, for example, unset.

The augmentation apparatus 10 outputs an augmented dataset 50 created by taking attributes that data of the target dataset 30 does not have from the outer dataset 40. Thus, data with variations that could not be obtained only from the target dataset 30 can be obtained. For example, according to the augmentation apparatus 10, even in a case in which the target dataset 30 includes only an image reflecting the back of a certain person, it is possible to obtain an image reflecting the front of the person.

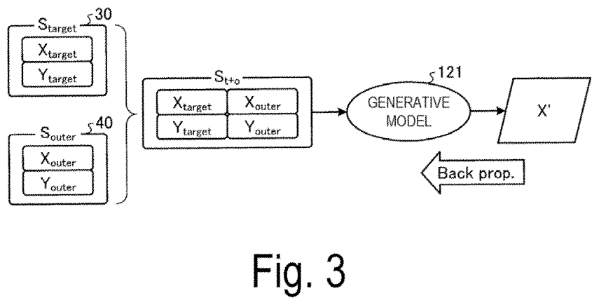

Learning processing by the learning unit 131 will be described using FIG. 3. FIG. 3 is a diagram for describing the learning processing of the generative model according to the first embodiment. As illustrated in FIG. 3, a dataset S_{target} is the target dataset 30. In addition, X_{target} and Y_{target} are data and a label for the dataset S_{target}, respectively. In addition, a dataset Sₒᵤₜₑᵣ is the outer dataset 40. Also, Xₒᵤₜₑᵣ and Yₒᵤₜₑᵣ are data and a label for the dataset Sₒᵤₜₑᵣ, respectively.

At this time, a domain of the target dataset 30 is represented as (X_{target}, Y_{target}, P(X_{target}, Y_{target})). In addition, a domain of the outer dataset 40 is represented as (Xₒᵤₜₑᵣ, Yₒᵤₜₑᵣ, P(Xₒᵤₜₑᵣ, Yₒᵤₜₑᵣ)).

The learning unit 131 first performs pre-processing on each piece of the data. For example, the learning unit 131 changes the size of an image to a uniform size (e.g. 128×128 pixels) as pre-processing. Then, the learning unit 131 combines the datasets S_{target} and Sₒᵤₜₑᵣ, and generates a dataset Sₜ₊ₒ. For example, Sₜ₊ₒ has the data and the label of S_{target} and Sₒᵤᵣₑᵣ stored in the same sequence, respectively.

Then, the learning unit 131 causes the generative model 121 to learn the generated dataset Sₜ₊ₒ as a correct dataset. A specific learning method is as described above. That is, the learning unit 131 performs learning such that the generator 121a of the generative model 121 can generate data that is proximate to the first data and the second data and the distinguisher 121b of the generative model 121 can distinguish a difference between the data generated by the generator 121a and the first data and a difference between data generated by the generator and the second data.

In addition, X′ in FIG. 3 is generative data generated by the generator 121a from the label of the dataset Sₜ₊ₒ. The learning unit 131 updates parameters of the generative model 121 using the method of backward propagation of errors based on the image X′.

The generating unit 132 generates the data for augmentation from the first label added to the first data using the generative model 121 that learned the first data and the second data. Y_{target} is an example of the first label added to the first data.

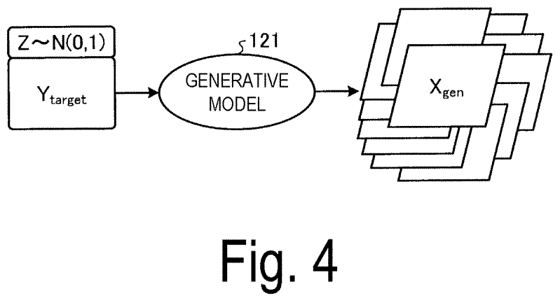

Generation processing by the generating unit 132 will be described using FIG. 4. FIG. 4 is a diagram for describing the generation processing of an augmented image according to the first embodiment. As illustrated in FIG. 4, the generating unit 132 inputs a label V_{target} into the generative model 121 along with noise Z to generate generative data X_{gen}. Here, the generative data X_{gen} is generated by the generator 121a. In addition, the generating unit 132 can cause the noise Z to be randomly generated according to a preset distribution to generate a plurality of pieces of generative data X_{gen}. Here, it is assumed that the distribution of the noise Z is a normal distribution of N(0, 1).

The adding unit 133 adds the first label added to the first data to augmented data obtained by integrating the first data and the data for augmentation. The adding unit 133 adds a label to the generative data X_{gen} generated by the generating unit 132 to generate a dataset S′_{target} that can be used by the learning apparatus 20. In addition, S′_{target} is an example of the augmented dataset 50.

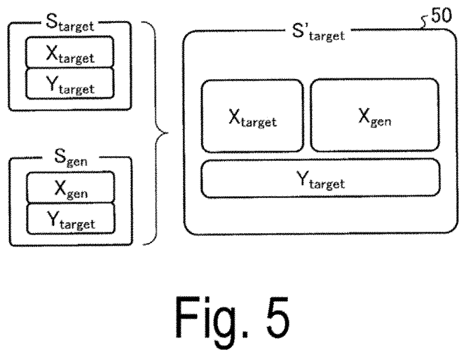

Adding processing by the adding unit 133 will be described with reference to FIG. 5. As illustrated in FIG. 5, the adding unit 133 adds Y_{target} as a label to the data obtained by integrating X_{target} and X_{gen}. At this time, the domain of the target dataset 30 is represented as (X_{target}+X_{gen}, Y_{target}, P(X_{target}+X_{gen}, Y_{target})).

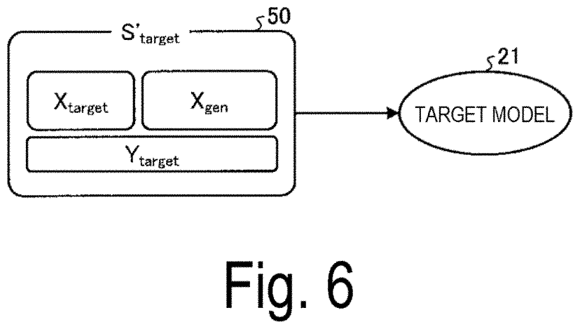

After that, as illustrated in FIG. 6, the learning apparatus 20 performs learning of the target model 21 using the dataset S′_{target}. FIG. 6 is a diagram for describing learning processing of the target model according to the first embodiment.

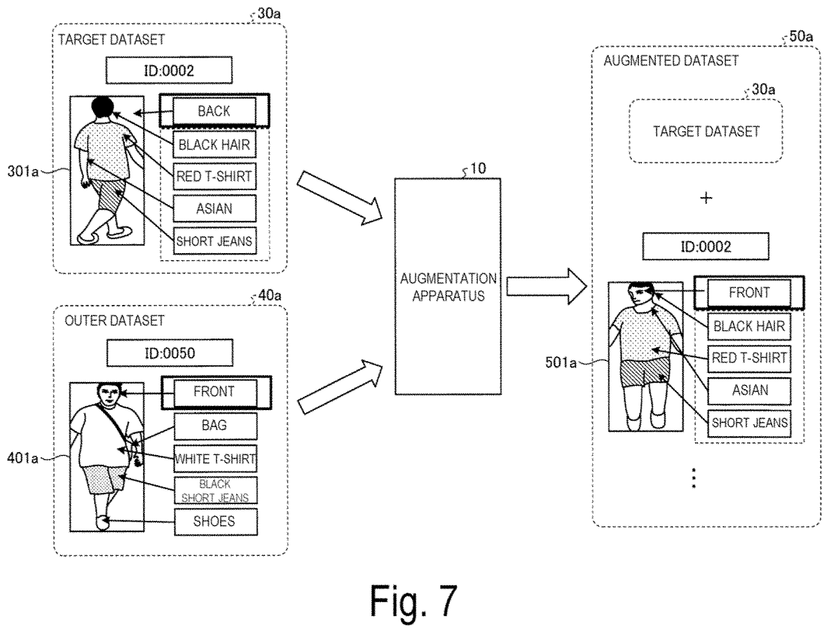

A specific example of the augmented dataset 50 will be described using FIG. 7. FIG. 7 is a diagram illustrating an example of the augmented dataset generated by the augmentation apparatus according to the first embodiment.

As illustrated in FIG. 7, a target dataset 30a includes an image 301a and a label “ID: 0002”. In addition, an outer dataset 40a includes an image 401a and a label “ID: 0050”. Here, the IDs included in the labels are to identify the persons in the images. In addition, the target dataset 30a and the outer dataset 40a may include images other than those illustrated.

The image 301a is assumed to reflect an Asian person with black hair, wearing a red T-shirt and short jeans and facing the back. In this case, the image 301a has attributes such as “back”, “black hair”, “red T-shirt”, “Asian”, and “short jeans”.

The image 401a is assumed to reflect a person carrying a bag on the shoulder, wearing a white T-shirt, black short jeans, and shoes, and facing the front. In this case, the image 401a has attributes such as “front”, “bag”, “white T-shirt”, “black short jeans”, and “shoes”.

Note that the attributes mentioned here are information used by the target model 21 in image recognition. However, these attributes are defined as examples for the purpose of description and are not necessarily explicitly treated as individual information in the image recognition processing. For this reason, the target dataset 30a and the outer dataset 40a may have unknown attributes.

The augmentation apparatus 10 inputs the target dataset 30a and the outer dataset 40a and outputs an augmented dataset 50a. An image for augmentation 501a is one of images generated by the augmentation apparatus 10. The augmented dataset 50a is a dataset obtained by integrating the target dataset 30a and the image for augmentation 501a to which the label “ID: 0002” is added.

The image for augmentation 501a is assumed to reflect an Asian person with black hair, wearing a red T-shirt and short jeans and facing the front. In this case, the image for augmentation 501a has attributes such as “front”, “black hair”, “red T-shirt”, “Asian”, and “short jeans”.

Here, the attribute “front” is an attribute that cannot be obtained from the target dataset 30a. As described above, the augmentation apparatus 10 can generate an image obtained by combining attributes obtained from the outer dataset 40a with the attributes of the target dataset 30a.

### Processing in First Embodiment

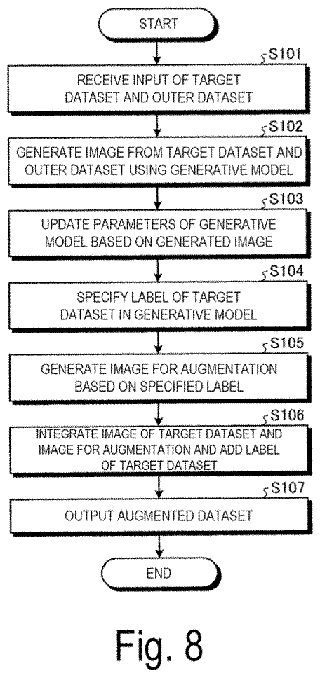

The flow of processing of the augmentation apparatus 10 will be described using FIG. 8. FIG. 8 is a flowchart illustrating the flow of processing of the augmentation apparatus according to the first embodiment. Here, the target model 21 is a model for performing image recognition, and data included in each dataset is images.

As shown in FIG. 8, first, the augmentation apparatus 10 receives inputs of the target dataset 30 and the outer dataset 40 (step S101). Next, the augmentation apparatus 10 uses the generative model 121 to generate images from the target dataset 30 and the outer dataset 40 (step S102). Then, the augmentation apparatus 10 updates parameters of the generative model 121 based on the generated images (step S103). That is, the augmentation apparatus 10 performs learning of the generative model 121 through steps S102 and S103. In addition, the augmentation apparatus 10 may also repeatedly perform steps S102 and S103 until predetermined conditions are met.

Here, the augmentation apparatus 10 specifies a label for the target dataset 30 in the generative model 121 (step S104) and generates an image for augmentation based on the specified label (step S105). Next, the augmentation apparatus 10 integrates the image of the target dataset 30 and the image for augmentation and adds the label of the target dataset 30 to the integrated data (step S106).

The augmentation apparatus 10 outputs the data to which the label is added in step S106 as the augmented dataset 50 (step S107). The learning apparatus 20 performs learning of the target model 21 using the augmented dataset 50.

### Effects of First Embodiment

As described so far, the augmentation apparatus 10 causes the generative model that generates data from labels to learn the first data and the second data to which labels have been added. In addition, the augmentation apparatus 10 uses the generative model that learned the first data and the second data to generate data for augmentation from the label added to the first data. In addition, the augmentation apparatus 10 adds the label added to the first data to augmented data obtained by integrating the first data and the data for augmentation. In this way, the augmentation apparatus 10 of the present embodiment can generate training data having attributes not included in the target dataset through the data augmentation. Thus, according to the present embodiment, the variation of the training data obtained by the data augmentation can be increased, and the accuracy of the model can be improved.

The augmentation apparatus 10 performs learning such that the generator of the generative model can generate data that is proximate to the first data and the second data and the distinguisher of the generative model can identify a difference between the data generated by the generator and the first data and a difference between the data generated by the generator and the second data. This enables the data generated using the generative model to be similar to the target data.

### Experimental Results

Here, an experiment performed to compare a technique in the related art and the embodiment will now be described. In the experiment, the target model 21 is MCCNN with Triplet loss in which a task of searching for a particular person from an image is performed using image recognition. In addition, the comparison of each of the techniques was performed through accuracy in recognition when data before augmentation, i.e., the target dataset 30, was input into the target model 21. The generative model 121 is a CGAN.

In addition, the target dataset 30 is “Market-1501” which is a dataset for person re-identification. Also, the outer dataset 40 is “CHUK03” which is also a dataset for person re-identification. In addition, an amount of data to be augmented is also three times an amount of original data.

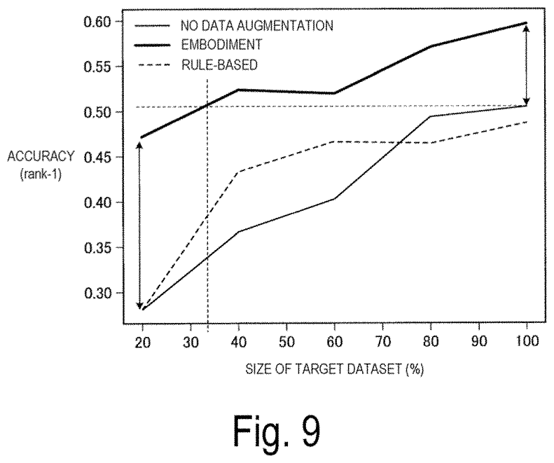

The results of the experiment are illustrated in FIG. 9. FIG. 9 is a diagram illustrating effects of the first embodiment. The horizontal axis represents the size of the target dataset 30 in percentage. Additionally, the vertical axis represents accuracy. In addition, the lines represent the case in which no data augmentation was performed, the case in which data augmentation was performed using the technique of the embodiment, and the case in which rule-based data augmentation of the related art was performed, respectively, as illustrated in FIG. 9.

As illustrated in FIG. 9, the case in which data augmentation was performed using the technique of the embodiment exhibits the highest accuracy regardless of data size. In particular, in the case in which data sizes were approximately 20%, the accuracy of the technique of the embodiment was improved by approximately 20% compared with the accuracy of the technique of the related art. In addition, in the case in which a data size was approximately 33%, the accuracy of the technique of the embodiment was equal to the accuracy of the technique of the related art in the case in which a data size was 100%. In addition, even in the case in which data sizes were 100%, the accuracy of the technique of the embodiment was improved by approximately 10% compared with the accuracy of the technique of the related art. As a result, the data augmentation according to the present embodiment is considered to further improve the recognition accuracy of the target model 21 compared to the technique of the related art.

### OTHER EMBODIMENTS

In the above embodiment, the learning function of the target model 21 is included in the learning apparatus 20 that is different from the augmentation apparatus 10. On the other hand, the augmentation apparatus 10 may include a target model learning unit that causes the target model 21 to learn the augmented dataset 50. This allows the augmentation apparatus 10 to reduce resource consumption resulting from data transfer between apparatuses and data augmentation and learning of the target model to be efficiently performed as a series of processing operations.

System Configuration, and the Like

Further, each illustrated constituent component of each apparatus is a conceptual function and does not necessarily need to be physically configured as illustrated in the drawings. That is, a specific form of distribution and integration of each apparatus is not limited to the form illustrated in the drawings, and all or some of the apparatuses can be distributed or integrated functionally or physically in any units according to various loads and use situations. Further, all or any part of each processing function to be performed by each apparatus can be implemented by a CPU and a program being analyzed and executed by the CPU, or can be implemented as hardware by wired logic.

In addition, among the processing operations described in the present embodiment, all or some of the processing operations described as being performed automatically can be performed manually, or all or some of the processing operations described as being performed manually can be performed automatically in a known method. In addition, information including the processing procedures, the control procedures, the specific names, and various data and parameters described in the above-described document and drawings can be optionally changed unless otherwise specified.

Program

As one embodiment, the augmentation apparatus 10 can be implemented by installing an augmentation program for executing the data augmentation described above as packaged software or on-line software in a desired computer. For example, by causing an information processing apparatus to execute the augmentation program, the information processing apparatus can function as the augmentation apparatus 10. Here, the information processing apparatus includes a desktop or notebook type personal computer. In addition, the information processing apparatus includes a mobile communication terminal such as a smartphone, a feature phone, and a Personal Handyphone System (PHS), or a slate terminal such as a Personal Digital Assistant (PDA) in the category.

In addition, the augmentation apparatus 10 can be implemented as an augmentation server apparatus that has a terminal apparatus used by a user as a client and provides services regarding the above-described data augmentation to the client. For example, the augmentation server apparatus is implemented as a server apparatus that provides an augmentation service in which target data is input and augmented data is output. In this case, the augmentation server apparatus may be implemented as a web server or may be implemented as a cloud that provides services regarding the data augmentation through outsourcing.

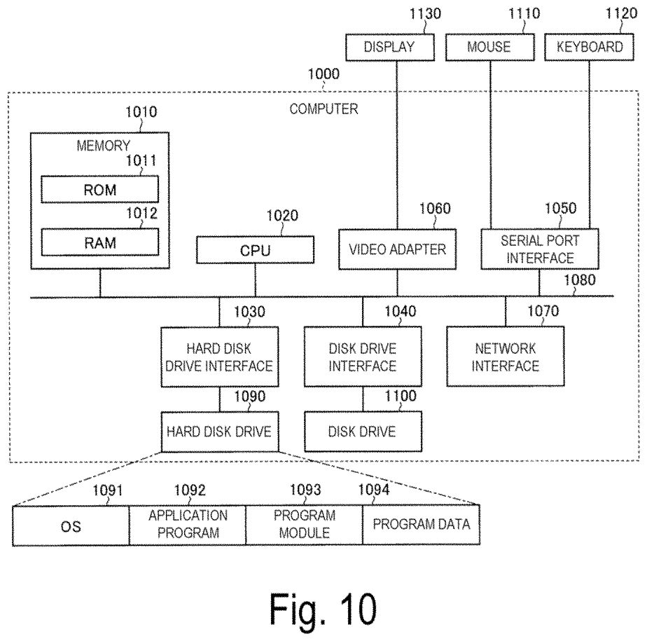

FIG. 10 is a diagram illustrating an example of a computer executing an augmentation program. The computer 1000 includes, for example, a memory 1010 and a CPU 1020. The computer 1000 includes a hard disk drive interface 1030, a disk drive interface 1040, a serial port interface 1050, a video adapter 1060, and a network interface 1070. These units are connected by a bus 1080.

The memory 1010 includes a Read Only Memory (ROM) 1011 and a RAM 1012. The ROM 1011 stores a boot program, for example, a Basic Input Output System (BIOS) or the like. The hard disk drive interface 1030 is connected to a hard disk drive 1090. The disk drive interface 1040 is connected to a disk drive 1100. A detachable storage medium, for example, a magnetic disk, an optical disc, or the like is inserted into the disk drive 1100. The serial port interface 1050 is connected to, for example, a mouse 1110 and a keyboard 1120. The video adapter 1060 is connected to, for example, a display 1130.

Here, the hard disk drive 1090 stores, for example, an OS 1091, an application program 1092, a program module 1093, and program data 1094. That is, a program defining each processing operation of the augmentation apparatus 10 is implemented as the program module 1093 in which a computer-executable code is written. The program module 1093 is stored in, for example, the hard disk drive 1090. For example, the program module 1093 for executing similar processing as for the functional configurations of the augmentation apparatus 10 is stored in the hard disk drive 1090. Note that the hard disk drive 1090 may be replaced with an SSD.

In addition, setting data used in the processing of the embodiment described above is stored as the program data 1094, for example, in the memory 1010 or the hard disk drive 1090. And then, the CPU 1020 reads the program module 1093 or the program data 1094 stored in the memory 1010 or the hard disk drive 1090 into the RAM 1012 as necessary, and executes the processing of the above-described embodiment.

Note that the program module 1093 or the program data 1094 is not limited to being stored in the hard disk drive 1090, and may be stored in, for example, a removable storage medium, and read by the CPU 1020 via the disk drive 1100 or the like. Alternatively, the program module 1093 and the program data 1094 may be stored in another computer connected via a network (a Local Area Network (LAN), a Wide Area Network (WAN), or the like). And then, the program module 1093 and the program data 1094 may be read by the CPU 1020 from another computer via the network interface 1070.

### REFERENCE SIGNS LIST

10 Augmentation apparatus
11 Input/output unit
12 Storage unit
13 Control unit
20 Learning apparatus
21 Target model
30, 30a Target dataset
40, 40a Outer dataset
50, 50a Augmented dataset
111 Input unit
112 Output unit
121 Generative model
121a Generator
121b Distinguisher
131 Learning unit
132 Generating unit
133 Adding unit
301a, 401a Image
501a Image for augmentation

1. An augmentation apparatus comprising:
learning circuitry configured to cause a generative model, which is configured to generate data from a label, to learn first data with a first label added and second data with a second label added;
generating circuitry configured to use the generative model that learned the first data and the second data to generate data for augmentation from the first label added to the first data; and
adding circuitry configured to add the first label added to the first data to augmented data obtained by integrating the first data and the data for augmentation.

2. The augmentation apparatus according to claim 1,
wherein the learning circuitry performs learning such that a generator of the generative model is capable of generating data that is proximate to the first data and the second data and a distinguisher of the generative model is capable of distinguishing a difference between data generated by the generator and the first data and a difference between data generated by the generator and the second data, and
the generating circuitry generates the data for augmentation using the generator.

3. The augmentation apparatus according to claim 1, further comprising:
target model learning circuitry configured to cause a target model to learn the augmented data with the first label added by the adding circuitry.

4. An augmentation method performed by a computer, the augmentation method comprising:
causing a generative model, which is configured to generate data from a label, to learn first data with a first label added and second data with a second label added;
using the generative model that learned the first data and the second data to generate data for augmentation from the first label added to the first data; and
adding the first label added to the first data to augmented data obtained by integrating the first data and the data for augmentation.

5. A non-transitory computer readable medium including computer instructions for causing a computer to operate as the augmentation apparatus according to claim 1.

6. A non-transitory computer readable medium including computer instructions which when executed cause a computer to perform the method of claim 4.
